(19) United States
(12) Patent Application Publication
(10) Pub. No.: US 2021/0223743 A1
(43) Pub. Date: Jul. 22, 2021

(54) Electronic Timepiece

(71) Applicant: Seiko Epson Corporation, Tokyo (JP)

(72) Inventor: Norimitsu BABA, Shiojiri (JP)

(21) Appl. No.: 17/152,857

(22) Filed: Jan. 20, 2021

(30) Foreign Application Priority Data
Jan. 21, 2020 (JP) 2020-007434

(51) Int. Cl. G04B 19/247; G04B 47/06; G04C 10/04; G04G 21/04

(52) U.S. Cl. CPC G04B 19/247; G04G 21/04; G04C 10/04; G04B 47/06

(57) ABSTRACT

An electronic timepiece of the present disclosure includes a first indicator wheel marked with numerals including a date, a second indicator wheel marked with a plurality of pieces of information, and a dial including a window configured to enable visual recognition of the numerals and the information. The electronic timepiece is configured to switch between a date display configured to use the numerals to display a date, and a function display obtained by combining the numerals and the information.

The present application is based on, and claims priority from JP Application Serial Number 2020-007434, filed Jan. 21, 2020, the disclosure of which is hereby incorporated by reference herein in its entirety.

### BACKGROUND

### 1. Technical Field

The present disclosure relates to an electronic timepiece.

### 2. Related Art

JP-A-2015-102530 discloses an electronic timepiece capable of displaying the time corresponding to every time zone in the world. In this electronic timepiece, time difference information indicating time differences from the Coordinated Universal Time (UTC) is displayed on a dial ring, and city information indicating representative cities that use the standard times corresponding to the time differences of the time difference information is displayed on a bezel. This makes it possible for a user to point a hand to the time difference information and the city information by operation of a crown or the like and check the time zone of a current location. That is, according to JP-A-2015-102530, the dial ring and the bezel are marked with time difference information and the like, making it possible to provide a world time function.

With the electronic timepiece of JP-A-2015-102530, the dial ring and the bezel need to be marked with the time difference information and the city information. Therefore, there is a problem in that it is difficult to apply such an electronic timepiece to a type of timepiece that preferably has a simple design with few characters and symbols marked on the dial ring and the bezel disposed on an outer edge of a dial visible surface.

### SUMMARY

An electronic timepiece of the present disclosure includes a first indicator wheel marked with numerals including a date, a second indicator wheel marked with a plurality of pieces of information, and a dial including a window configured to enable visual recognition of the numerals and the information. The electronic timepiece is configured to switch between a date display configured to use the numerals to display a date, and a function display obtained by combining the numerals and the information.

An electronic timepiece of the present disclosure includes a first indicator wheel marked with numerals, including a date, a dial including a window configured to enable visual recognition of the numerals, and marked with a plurality of pieces of information, and an information indicating hand configured to point to the information. The electronic timepiece is configured to switch between a date display configured to use the numerals to display a date, and a function display obtained by combining the numerals and the information.

### BRIEF DESCRIPTION OF THE DRAWINGS

FIG. 1 is a front view schematically illustrating an electronic timepiece of a first exemplary embodiment.

FIG. 2 is a cross-sectional view schematically illustrating the electronic timepiece of the first exemplary embodiment.

FIG. 3 is a plan view illustrating a layout of an interior of the electronic timepiece of the first exemplary embodiment.

FIG. 4 is a drawing schematically illustrating a date indicator and an information indicator wheel of the first exemplary embodiment.

FIG. 5 is a drawing illustrating a circuit configuration of the electronic timepiece of the first exemplary embodiment.

FIG. 6 is a drawing illustrating a configuration of an IC of the first exemplary embodiment.

FIG. 7 is a flowchart illustrating time zone selection processing.

FIG. 8 is a drawing illustrating an example of displaying a time zone of +5.5 hours.

FIG. 9 is a drawing illustrating an example of displaying a time zone of +5.75 hours.

FIG. 10 is a front view schematically illustrating an electronic timepiece of a second exemplary embodiment.

FIG. 11 is a drawing schematically illustrating a date indicator and an information indicator wheel of the second exemplary embodiment.

FIG. 12 is a drawing illustrating a circuit configuration of the electronic timepiece of the second exemplary embodiment.

FIG. 13 is a front view schematically illustrating an electronic timepiece of a third exemplary embodiment.

FIG. 14 is a drawing schematically illustrating a date indicator and an information indicator wheel of the third exemplary embodiment.

FIG. 15 is a drawing illustrating a circuit configuration of the electronic timepiece of the third exemplary embodiment.

FIG. 16 is a drawing schematically illustrating a date indicator and an information indicator wheel of a first modification example.

FIG. 17 is a front view schematically illustrating an electronic timepiece of a second modification example.

FIG. 18 is a front view schematically illustrating an electronic timepiece of a third modification example.

FIG. 19 is a front view schematically illustrating an electronic timepiece of a fourth modification example.

FIG. 20 is a front view schematically illustrating an electronic timepiece of a fifth modification example.

### DESCRIPTION OF EXEMPLARY EMBODIMENTS

### First Exemplary Embodiment

An electronic timepiece 1 of a first exemplary embodiment of the present disclosure will be described below with reference to the drawings.

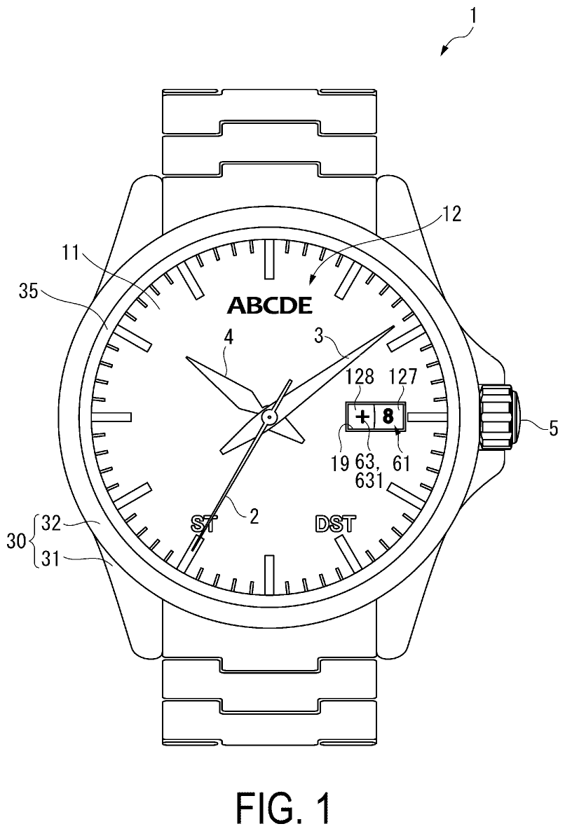

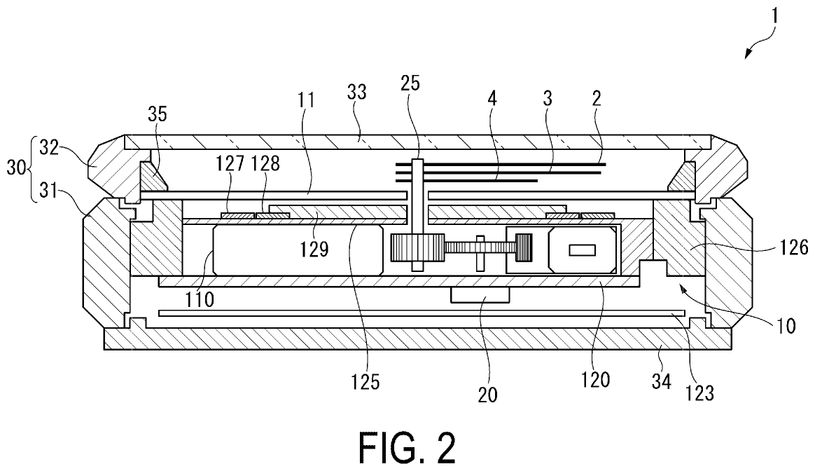

FIG. 1 is a front view schematically illustrating the electronic timepiece 1 of this exemplary embodiment, and FIG. 2 is a cross-sectional view schematically illustrating the electronic timepiece 1.

As illustrated in FIGS. 1 and 2, the electronic timepiece 1 is a watch worn on a wrist of a user and includes an outer case 30, a cover glass 33, and a case back 34. The outer case 30 is configured by fitting a bezel 32 to a case main body 31 formed of a metal and having a cylindrical shape. A dial ring 35 having a ring shape and a dial 11 formed into a disc shape are disposed on an inner circumferential side of the bezel 32. That is, the bezel 32 and the dial ring 35 are disposed on an outer edge of a visible surface of the dial 11.

A crown 5 is provided to a side surface of the outer case 30, in a position in a 3 o'clock direction from a planar center of the dial 11.

Of two openings of the outer case 30, an opening on a front surface side is closed by the cover glass 33 with the bezel 32 interposed therebetween, and an opening on a back surface side is closed by the case back 34 formed of a metal.

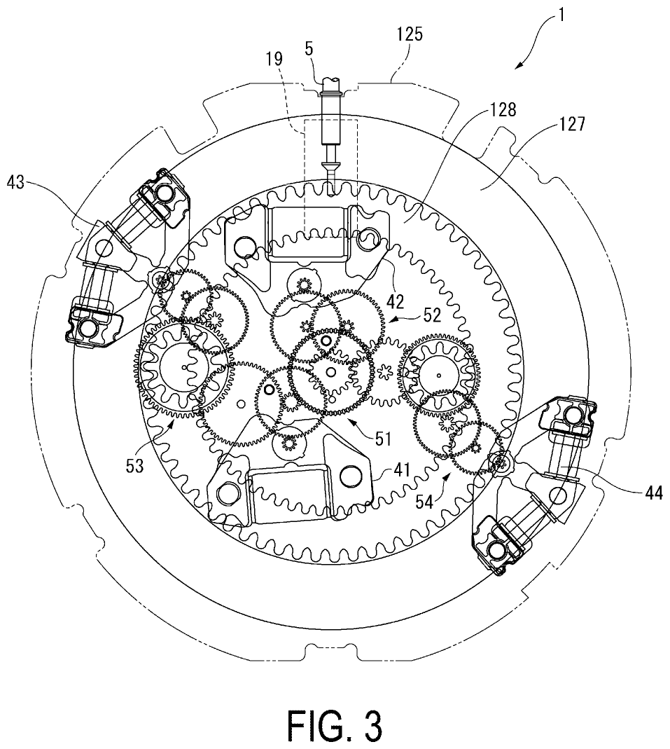

FIG. 3 is a plan view illustrating a layout of an interior of the electronic timepiece 1.

As illustrated in FIGS. 1 to 3, the dial ring 35, the dial 11, a seconds hand 2, a minute hand 3, an hour hand 4, a movement 10, and the like are provided on an inner side of the outer case 30.

The dial ring 35 includes a flat plate portion in which an outer circumferential edge of the dial ring 35 is in contact with an inner circumferential surface of the bezel 32 and parallel to the cover glass 33, and an inclined portion inclined toward the dial 11.

The dial 11 is a plate material having a circular shape configured to display a time on the inner side of the outer case 30, and is disposed on the back surface side of the dial ring 35.

A logo 12 is provided on the front surface side of the dial 11. The logo 12 is characters, numerals, or a mark indicating a product name or a manufacturer name, and is formed of a metal, a resin, or the like. Note that the logo 12 may be formed by printing.

A dial receiving ring 126 configured to hold the dial 11 is provided on the back surface side of the dial 11. The dial receiving ring 126 has a ring shape along an inner circumferential surface of the outer case 30.

The movement 10 is configured to include an IC 20, a hand shaft 25, a first motor 41, a second motor 42, a third motor 43, a fourth motor 44, a first wheel train 51, a second wheel train 52, a third wheel train 53, a fourth wheel train 54, a battery 110, a printed wired board 120, a main plate 125, the dial receiving ring 126, a date indicator 127, an information indicator wheel 128, an indicator wheel holder 129, and the like. Note that the date indicator 127 is an example of the first indicator wheel of the present disclosure, and the information indicator wheel 128 is an example of the second indicator wheel of the present disclosure.

The guide shaft 25 is provided along a center axis extending in a front-back direction through a planar center of the outer case 30, and the seconds hand 2, the minute hand 3, and the hour hand 4 are attached thereto.

The first motor 41 drives the first wheel train 51 to move the seconds hand 2. The second motor 42 drives the second wheel train 52 to move the minute hand 3 and the hour hand 4. The third motor 43 drives the third wheel train 53 to rotationally move the date indicator 127. The fourth motor 44 drives the fourth wheel train 54 to rotationally move the information indicator wheel 128.

Note that the third motor 43 and the third wheel train 53 are an example of the first driving mechanism of the present disclosure configured to drive the date indicator 127, and the fourth motor 44 and the fourth wheel train 54 are an example of the second driving mechanism of the present disclosure configured to drive the information indicator wheel 128.

Further, each of the motors 41 to 44 is a step motor for a timepiece, and the third motor 43 and the fourth motor 44 are two-coil step motors including two coils. Normally, when operation is carried out using one coil, a speed in a forward rotation direction and a speed in a reverse rotation direction of the wheel differ. However, because the third motor 43 and the fourth motor 44 of this exemplary embodiment include two coils, one coil can carry out operation of the wheel in the forward rotation direction and the other coil can carry out operation of the wheel in the reverse rotation direction, making it possible to rotate the wheel forward and in reverse at the same speed. When one coil is operated, the other coil can be controlled simultaneously, that is, the two coils can be used, making it possible to rotationally move the wheel quickly in the forward rotation direction and the reverse rotation direction.

The date indicator 127, the information indicator wheel 128, and the indicator wheel holder 129 are provided between the main plate 125 and the dial 11. The date indicator 127 is marked with numerals 61. Note that, in this exemplary embodiment, the numerals 61 indicate dates, and thus the date indicator 127 is marked with “1” to “31” as the numerals 61.

Further, the information indicator wheel 128 is marked with a plurality of symbols 63 indicating information. Then, in this exemplary embodiment, the indicator wheel holder 129 presses the information indicator wheel 128 from the dial 11 side, thereby holding the information indicator wheel 128. Further, the information indicator wheel 128 presses the date indicator 127 from the dial 11 side, thereby holding the date indicator 127. Note that details of the date indicator 127 and the information indicator wheel 128 will be described later.

Holes through which the guide shaft 25 passes are formed in the dial 11, the indicator wheel holder 129, and the main plate 125. Further, an opening portion of a display window 19 is formed in the dial 11. Note that, in this exemplary embodiment, the display window 19 is provided at a position corresponding to the date indicator 127 and the information indicator wheel 128, in the 3 o'clock direction from the planar center of the dial 11. That is, a user can visually recognize the numerals 61 marked on the date indicator 127 and the symbols 63 marked on the information indicator wheel 128 through the display window 19. Note that the display window 19 is an example of the window of the present disclosure.

The printed wired board 120 is provided with the IC 20. The battery 110 is a button-type silver oxide battery or lithium battery formed into a planar circular shape, and supplies power to the IC 20.

A battery terminal plate (not illustrated) is disposed on the case back side of the battery 110, and the battery terminal plate is electrically coupled to the printed wired board 120. Further, a circuit holder 123 is provided on a back surface side of the printed wired board 120.

Date Indicator and Information Indicator Wheel

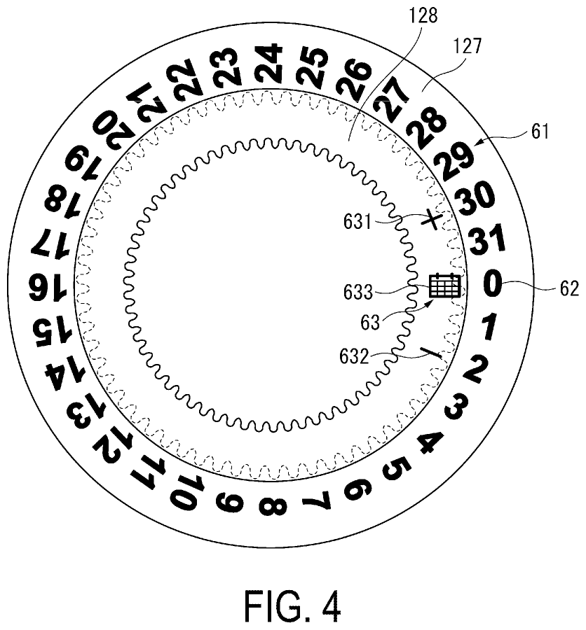

FIG. 4 is a drawing schematically illustrating the date indicator 127 and the information indicator wheel 128.

As illustrated in FIG. 4, the date indicator 127 is formed into a circular shape, and marked with the numerals 61 indicating dates. Then, in this exemplary embodiment, in addition to the numerals 61 of “1” to “31” indicating dates, the date indicator 127 is marked with a character 62 of “0”. That is, in this exemplary embodiment, the date indicator 127 is marked with numerals including dates. Note that the character 62 is not limited to the above-described configuration, and may be constituted by, for example, the characters of “UTC”.

The information indicator wheel 128 is formed into a circular shape and disposed in a space on an inner circumferential side of the date indicator 127. Then, the information indicator wheel 128 is disposed at substantially the same height position with the date indicator 127 in a thickness direction of the electronic timepiece 1. This makes it possible to reduce a thickness dimension of the electronic timepiece 1 and make the electronic timepiece 1 thinner. Furthermore, the date indicator 127 and the information indicator wheel 128 are disposed on substantially the same plane, making it possible to ensure that a step substantially does not occur between the date indicator 127 and the information indicator wheel 128. Therefore, a sense of integration of the display can be enhanced by the date indicator 127 and the information indicator wheel 128, and visibility can be improved. Note that, in the present disclosure, the thickness direction of the electronic timepiece 1 is described as a direction orthogonal to a front surface of the date indicator 127 and the information indicator wheel 128.

Further, in this exemplary embodiment, the information indicator wheel 128 is marked with the symbols 63 indicating information. Specifically, the information indicator wheel 128 is marked with a plus sign 631, a minus sign 632, and a calendar icon 633 indicating a calendar as the symbols 63 indicating information.

Then, in this exemplary embodiment, the electronic timepiece 1 is configured to switch the information displayed through the display window 19 between a date display and a time difference information display to display the date display or the time difference information display. That is, the electronic timepiece 1 is configured to switch a display mode to calendar mode configured to display the date and to time difference information mode configured to display time difference information. Specifically, when the display mode is calendar mode, the electronic timepiece 1 is configured to display the calendar icon 633 and the numerals 61 indicating the date through the display window 19. That is, the electronic timepiece 1 uses the numerals to display the date. Note that the display of this date is an example of the date display of the present disclosure.

Further, when the display mode is time difference information mode, the electronic timepiece 1 is configured to display the plus sign 631 or the minus sign 632 and the numerals 61 indicating the time difference through the display window 19. For example, as illustrated in FIG. 1, the electronic timepiece 1 is configured to display the time difference information indicating a “+8 hours” time difference from the UTC by displaying the plus sign 631 and “8” of the numerals 61 through the display window 19. That is, the electronic timepiece 1 is configured to be capable of displaying a time difference information display obtained by combining the numerals 61 and the symbols 63. Note that the time difference information display is an example of the function display of the present disclosure.

Note that the configuration is not limited to the above-described configuration. For example, when the display mode is calendar mode, the electronic timepiece 1 may be configured to display, through the display window 19, a blank portion of the information indicator wheel 128, that is, a location where nothing is marked.

Furthermore, when the character 62 is constituted by the characters “UTC”, the electronic timepiece 1 may be configured to display, through the display window 19, the blank portion of information indicator wheel 128 and the character 62 when displaying time difference information of “+0 hours”.

Circuit Configuration of Electronic Timepiece

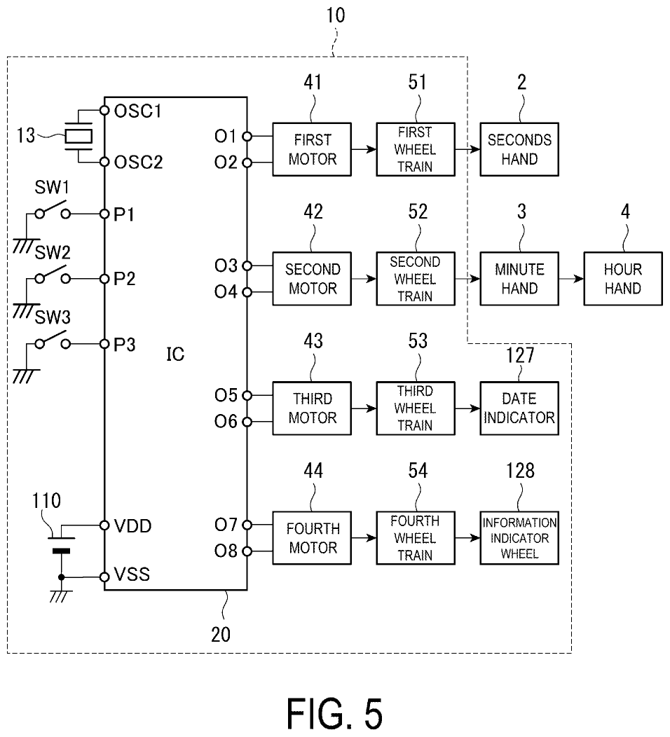

FIG. 5 is a drawing illustrating a circuit configuration of the electronic timepiece 1.

As illustrated in FIG. 5, the movement 10 includes a crystal oscillator 13 which is a signal source, a switch SW1 turned on and off in conjunction with a pullout operation of the crown 5, a rotation switch SW2 turned on and off in accordance with the rotation of the crown 5 in the clockwise direction, a rotation switch SW3 turned on and off in accordance with the rotation of the crown 5 in the counterclockwise direction, and the IC 20 for a timepiece.

The IC 20 includes coupling terminals OSC1, OSC2 to which the crystal oscillator 13 is coupled, an input-output terminal P1 to which the switch SW1 is coupled, an input-output terminal P2 to which the rotation switch SW2 is coupled, an input-output terminal P3 to which the rotation switch SW3 is coupled, power supply terminals VDD, VSS to which the battery 110 is coupled, and output terminals O1 to O8 to which the coils of the respective motors 41 to 44 are coupled.

In this exemplary embodiment, a positive electrode of the battery 110 is coupled to the power supply terminal VDD on a high potential side, a negative electrode of the battery 110 is coupled to the power supply terminal VSS on a low potential side, and the power supply terminal VSS on the low potential side is set to ground. Note that IC is an abbreviation for integrated circuit.

Circuit Configuration of IC

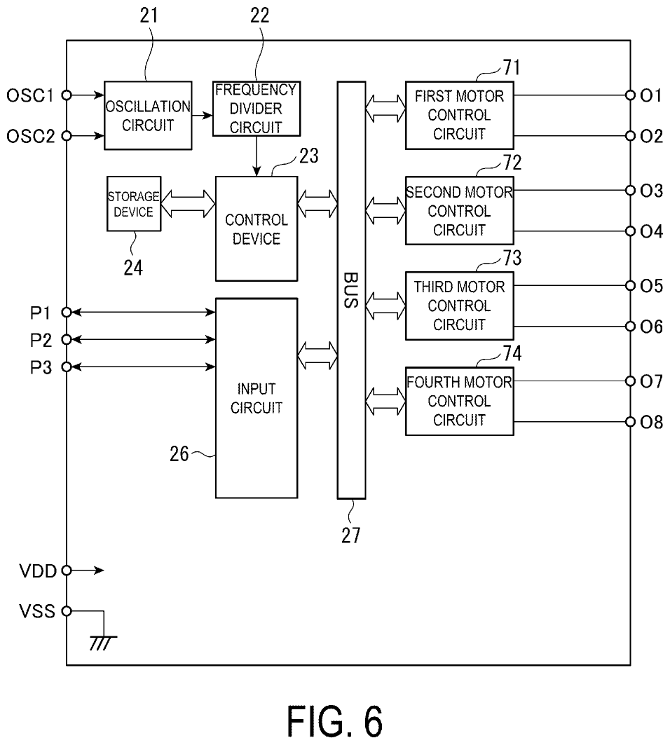

FIG. 6 is a drawing illustrating a circuit configuration of the IC 20.

As illustrated in FIG. 6, the IC 20 includes an oscillation circuit 21, a frequency divider circuit 22, a control device 23, a storage device 24, an input circuit 26, a BUS 27, a first motor control circuit 71, a second motor control circuit 72, a third motor control circuit 73, and a fourth motor control circuit 74.

In this exemplary embodiment, the control device 23 is constituted by a so-called CPU or the like, and the storage device 24 is constituted by a memory such as a so-called RAM. Note that CPU is an abbreviation for “central processing unit” and RAM is an abbreviation for “random access memory”.

The oscillation circuit 21 oscillates the crystal oscillator 13, which is a reference signal source, at high frequency, and outputs an oscillation signal at a predetermined frequency generated by this high frequency oscillation to the frequency divider circuit 22. Note that the predetermined frequency is 32768 Hz. The frequency divider circuit 22 divides the output of the oscillation circuit 21 into predetermined frequencies, and supplies a timing signal to the control device 23. The storage device 24 stores various programs executed by the control device 23 and a time difference information table described later. The control device 23 executes programs stored in the storage device 24.

The input circuit 26 outputs the state of the input-output terminals P1, P2, P3 to the BUS 27. The BUS 27 is used to transfer data between the control device 23, the input circuit 26, and each of the motor control circuits 71 to 74, and the like.

The first motor control circuit 71 outputs a predetermined drive signal to the first motor 41 by an instruction input from the control device 23 through the BUS 27. The second motor control circuit 72 outputs a predetermined drive signal to the second motor 42 by an instruction input from the control device 23 through the BUS 27. The third motor control circuit 73 outputs a predetermined drive signal to the third motor 43 by an instruction input from the control device 23 through the BUS 27. The fourth motor control circuit 74 outputs a predetermined drive signal to the fourth motor 44 by an instruction input from the control device 23 through the BUS 27.

Time Zone Selection Processing

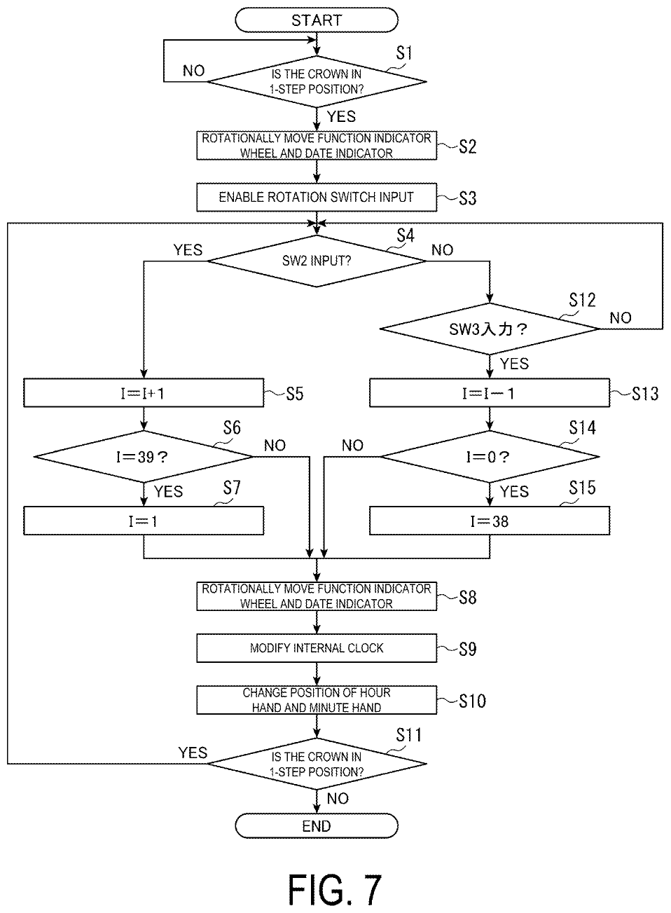

Next, the time zone selection processing of this exemplary embodiment will be described using the flowchart of FIG. 7 and the time difference information table of Table 1.

TABLE 1

| | | Display of | |
|---|---|---|---|
| | | Information | |
| Index | Time | Indicator | Display of Date |
| I | Zone | Wheel | Indicator |
| 1 | +0 | + | 0 |
| 2 | +1 | + | 1 |
| 3 | +2 | + | 2 |
| 4 | +3 | + | 3 |
| 5 | +3.5 | + | In the middle of 3 and 4 |
| 6 | +4 | + | 4 |
| 7 | +4.5 | + | In the middle of 4 and 5 |
| 8 | +5 | + | 5 |
| 9 | +5.5 | + | In the middle of 5 and 6 |
| 10 | +5.75 | + | Position between 5 and 6, closer to 6 |
| 11 | +6 | + | 6 |
| 12 | +6.5 | + | In the middle of 6 and 7 |
| 13 | +7 | + | 7 |
| 14 | +8 | + | 8 |
| 15 | +8.75 | + | Position between 8 and 9, closer to 8 |
| 16 | +9 | + | 9 |
| 17 | +9.5 | + | Between 9 and 10 |
| 18 | +10 | + | 10 |
| 19 | +10.5 | + | Between 10 and 11 |
| 20 | +11 | + | 11 |
| 21 | +12 | + | 12 |
| 22 | +12.75 | + | Position between 12 and 13, closer to 13 |
| 23 | +13 | + | 13 |
| 24 | +14 | + | 14 |
| 25 | −12 | − | 12 |
| 26 | −11 | − | 11 |
| 27 | −10 | − | 10 |
| 28 | −9.5 | − | In the middle of 9 and 10 |
| 29 | −9 | − | 9 |
| 30 | −8 | − | 8 |
| 31 | −7 | − | 7 |
| 32 | −6 | − | 6 |
| 33 | −5 | − | 5 |
| 34 | −4 | − | 4 |
| 35 | −3.5 | − | In the middle of 3 and 4 |
| 36 | −3 | − | 3 |
| 37 | −2 | − | 2 |
| 38 | −1 | − | 1 |

As illustrated in FIG. 7, first, as step S1, the control device 23 determines whether or not the crown 5 has been pulled one step by input from the switch SW1.

When the control device 23 determines No in step S1, the control device 23 repeats the processing of step S1.

On the other hand, when Yes is determined in step S1, as step S2, the control device 23 controls the third motor control circuit 73 and the fourth motor control circuit 74 to rotationally move the date indicator 127 and the information indicator wheel 128, and thus displays the time difference information for the time zone currently set. That is, the control device 23 sets the display mode to time difference information mode. Specifically, the control device 23 rotationally moves the date indicator 127 and the information indicator wheel 128 on the basis of Index I shown in Table 1. For example, when “16” is set in the storage device 24 as the Index I, that is, when the time zone of “+9 hours” is set, the control device 23 rotationally moves the date indicator 127 and the information indicator wheel 128, and thus displays the plus sign 631 and “9” of the numerals 61 through the display window 19.

Next, as step S3, the control device 23 enables input of the rotation switches SW2, SW3 of the crown 5.

Then, as step S4, the control device 23 determines whether or not rotation in the clockwise direction by the crown 5 was input by input from the rotation switch SW2.

When Yes is determined in step S4, as step S5, the control device 23 sets “I=I+1”, that is, the value obtained by adding 1 to the Index I currently set, as the new value of the Index I.

Next, as step S6, the control device 23 determines whether or not “I=39”, that is, whether the value of the Index I currently set is “39”.

When Yes is determined in step S6, because there is no time zone in which the value of the Index I is “39” as shown in Table 1, as step S7, the control device 23 sets “I=1”, that is, newly sets “1” as the value of the Index I. As shown in Table 1, there are only 38 time zones corresponding to the Index I, and thus the time zone is configured to return to “1” when the value of I exceeds 38.

Then, as step S8, the control device 23 rotationally moves the date indicator 127 and the information indicator wheel 128 on the basis of the Index I currently set.

On the other hand, when No is determined in step S6, the value of the Index I is not changed and the processing of step S8 described above is performed. At this time, in this exemplary embodiment, the third motor 43 and the fourth motor 44 that rotationally move the date indicator 127 and the information indicator wheel 128 are configured as two-coil step motors. Therefore, the date indicator 127 and the information indicator wheel 128 can be rotationally moved at high speed in both the forward rotation direction and the reverse rotation direction. Therefore, the control device 23 can rotationally move the date indicator 127 and the information indicator wheel 128 in a short time to positions corresponding to the Index I currently set. For example, when the value of the Index I is changed from “24” to “25”, the control device 23 rotationally moves the information indicator wheel 128 in the forward rotation direction (counterclockwise direction), thereby changing the symbol 63 displayed through the display window 19 from the plus sign 631 to the minus sign 632. Then, the control device 23 rotationally moves the date indicator 127 in the reverse rotation direction (clockwise direction), thereby changing the numeral 61 displayed through the display window 19 from “14” to “12”. Thus, the display corresponding to the Index I can be changed in a short time.

Here, as in the case where the value of the Index I in Table 1 is “9”, the time difference from the UTC of the set time zone may be “+5.5 hours”, that is, a time difference including a decimal point.

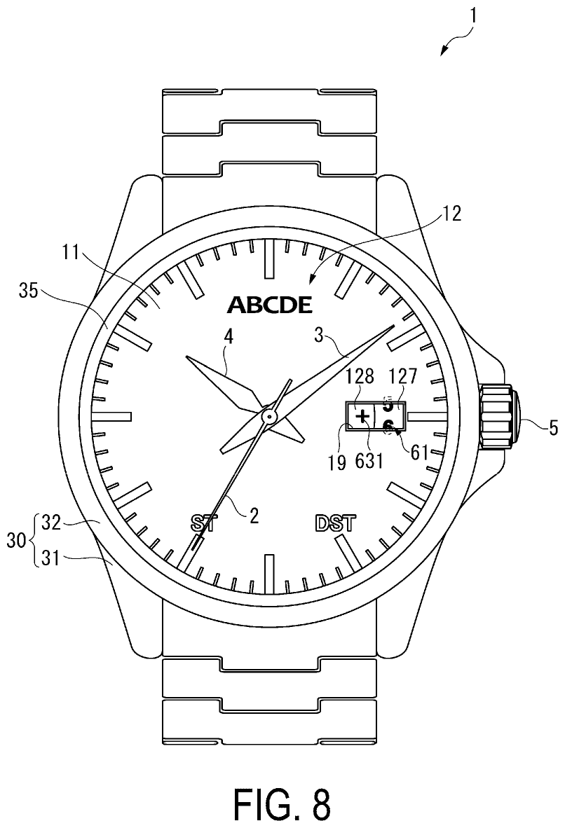

In this case, as illustrated in FIG. 8, the control device 23 rotationally moves the date indicator 127, causing the position in the middle of “5” and “6” to be displayed through the display window 19.

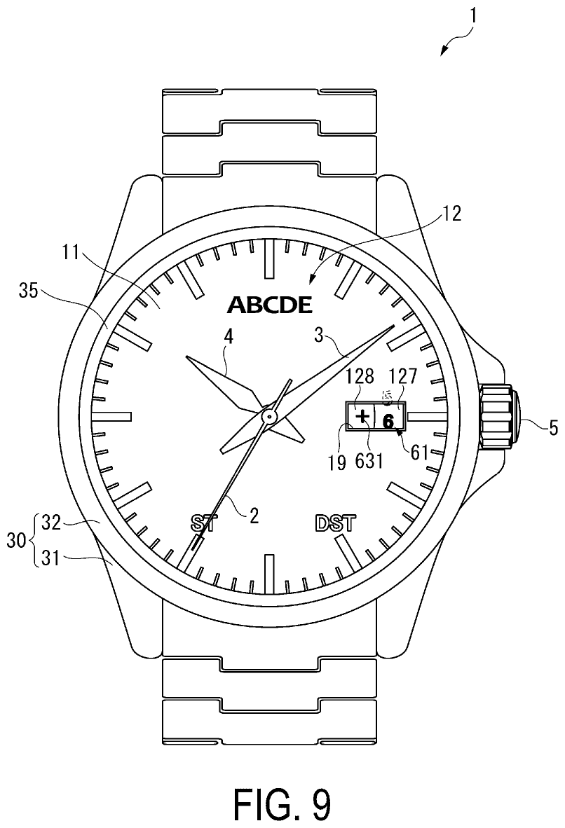

Further, when the value of the Index I is “10”, that is, when the time difference from the UTC of the set time zone is “+5.75 hours”, the control device 23 rotationally moves the date indicator 127, causing the position between “5” and “6”, closer to “6”, to be displayed through the display window 19, as illustrated in FIG. 9.

Thus, in this exemplary embodiment, the electronic timepiece 1 is configured to display the numeral 61 corresponding to the time difference information through the display window 19 when time difference information not including a decimal point is to be displayed, and display a position between the numerals 61 adjacent to each other through the display window 19 in accordance with the time difference information when time difference information including a decimal point is to be displayed.

Note that, in addition to being expressed by numerals including a decimal point as in the “+5.5 hours” described above, the time difference information may be expressed by hours and minutes as in “+5 hours 30 minutes”. In this specification, even when expressed by hours and minutes as in “+5 hours 30 minutes”, the time difference information is handled as a numerals including a decimal point as in “+5.5 hours”.

Returning to FIG. 7, as step S9, the control device 23 modifies the internal clock on the basis of the value of the Index I currently set. Then, as step S10, the control device 23 controls the second motor control circuit 72 on the basis of the modified internal clock, thereby moving the minute hand 3 and the hour hand 4 to positions corresponding to the internal clock.

Subsequently, as step S11, the control device 23 determines whether or not the crown 5 has been pulled one step by input from the switch SW1.

When Yes is determined in step S11, the flow returns to step S4 to repeat the processing.

On the other hand, in a case where No is determined in step S11, the control device 23 ends the time zone selection processing and sets the display mode to calendar mode. That is, the control device 23 switches the display mode from time difference information mode to calendar mode.

Returning to step S4, when No is determined in step S4, as step S12, the control device 23 determines whether or not rotation in the clockwise direction by the crown 5 was input by input from the rotation switch SW2.

When No is determined in step S12, the flow returns to step S4 to repeat the processing.

On the other hand, when Yes is determined in step S12, as step S13, the control device 23 sets “I=I−1”, that is, the value obtained by subtracting 1 from the value of the Index I currently set, as the new Index I.

Next, as step S14, the control device 23 determines whether or not “I=0”, that is, whether or not the value of the Index I current set is “0”.

When Yes is determined in step S14, because there is no time zone in which the value of the Index I is “0” as shown in Table 1, as step S15, the control device 23 sets “I=38”, that is, newly sets “38” as the value of the Index I. Then, step S8 and the subsequent processing described above are performed.

On the other hand, when No is determined in step S14, step S8 and the subsequent processing described above are performed.

Here, in this exemplary embodiment, during the time zone selection processing, the seconds hand 2 points to whether daylight saving time is on or off. Specifically, the seconds hand 2 points to characters “DST” illustrated in FIG. 1 when daylight saving time is on, and points to characters “ST” when daylight saving time is off.

Then, in this exemplary embodiment, the electronic timepiece 1 is configured to switch daylight saving time on and off when the crown 5 is changed from the 1-step position to the 0-step position and then from the 0-step position to the 1-step position within one second during the time zone selection processing.

If daylight saving time is on, then the internal clock is set to +1 hour.

Note that the electronic timepiece 1 is not limited to the above-described configuration, and need not be configured to switch daylight saving time on and off, for example. In this case, the characters “DST” and “ST” need not be marked on the dial 11.

Further, when the time zone selection processing is completed and the display mode is set to calendar mode, the control device 23 moves the seconds hand 2 to a position corresponding to the internal clock.

### Advantageous Effects of First Exemplary Embodiment

According to such a first exemplary embodiment, the following advantageous effects can be achieved.

In this exemplary embodiment, the electronic timepiece 1 includes the date indicator 127 marked with the numerals 61 including dates, the information indicator wheel 128 marked with a plurality of symbols 63 indicating information, and the dial 11 including the display window 19 for visually recognizing the numerals 61 and the symbols 63. Then, the electronic timepiece 1 is configured to be switchable between the date display configured to use the numerals 61 to display the date, and the time difference information display, which is a function display obtained by combining the numerals 61 and the symbols 63. Thus, the time difference information and the like can be displayed without marking the dial ring 35, the bezel 32, and the like with characters or symbols. This makes it possible to simplify the design of the dial ring 35 and the bezel 32 disposed on the outer edge of the visible surface of the dial 11.

Furthermore, when the dial ring 35, the bezel 32, and the like are marked with characters and symbols, the characters and the symbols thus marked are decreased in size, deteriorating visibility. On the other hand, in this exemplary embodiment, the date indicator 127 and the information indicator wheel 128 are marked with the numerals 61 and the symbols 63, making it possible to suppress the decrease in size of the numerals 61 and the symbols 63 and suppress the deterioration in visibility.

In this exemplary embodiment, the information indicator wheel 128 is disposed on an inner side of the date indicator 127.

Thus, the information indicator wheel 128 is disposed in the space on the inner circumferential side of the date indicator 127, making it possible to effectively utilize the space in the interior of the electronic timepiece 1. Therefore, the electronic timepiece 1 can be miniaturized.

Further, in this exemplary embodiment, the date indicator 127 is disposed on an outer circumferential side of the information indicator wheel 128, making it possible to increase the area of the date indicator 127 that can be marked with the numerals 61. That is, the area that can be marked with the numerals 61, of which there are many, can be increased, making it possible to increase the size of the numerals 61 and make the numerals 61 easily viewable.

Furthermore, in this exemplary embodiment, the date indicator 127 and the information indicator wheel 128 are disposed at substantially the same height in the thickness direction of the electronic timepiece 1, making it possible to make the electronic timepiece 1 thinner and improve visibility.

In this exemplary embodiment, the electronic timepiece 1 includes the third motor 43 and the third coil 53 configured to drive the date indicator 127, and the fourth motor 44 and the fourth wheel train 54 configured to drive the information indicator wheel 128. Thus, because the date indicator 127 and the information indicator wheel 128 are rotationally moved by different driving mechanisms, the date indicator 127 and the information indicator wheel 128 can be rotationally moved to predetermined positions in a short time compared to when the date indicator 127 and the information indicator wheel 128 are rotationally moved by the same driving mechanism.

Furthermore, in this exemplary embodiment, the third motor 43 and the fourth motor 44 configured to drive the date indicator 127 and the information indicator wheel 128 are configured as two-coil step motors, making it possible to rotationally move the date indicator 127 and the information indicator wheel 128 to predetermined positions in a shorter time.

In this exemplary embodiment, in addition to the numerals 61 indicating dates, the date indicator 127 is marked with the character 62 of “0”, and the numerals 61, the symbols 63, and the character 62 are combined to display time difference information as the function display. This makes it possible to display time difference information for the time zone of “+0 hours”.

In this exemplary embodiment, when time difference information including a decimal point is to be displayed, a position between the numerals 61 adjacent to each other is displayed through the display window 19 in accordance with the time difference information. Thus, even with time difference information including a decimal point, the time difference information can be displayed by the numerals 61 and the symbols 63.

In this exemplary embodiment, the electronic timepiece 1 can set daylight saving time on and off. Then, during the time zone selection processing, the seconds hand 2 can point to the on and off setting of daylight saving time. Therefore, the user can easily set daylight saving time to on or off.

### Second Exemplary Embodiment

Next, an electronic timepiece 1A of a second exemplary embodiment of the present disclosure will be described with reference to the drawings.

The electronic timepiece 1A of the second exemplary embodiment differs from that of the first exemplary embodiment described above in that an information indicator wheel 128A is marked with a satellite icon or the like for displaying reception of satellite signals. Note that components of the second exemplary embodiment that are identical or similar to the corresponding components of the first exemplary embodiment are denoted by identical reference signs and that descriptions of these components are omitted.

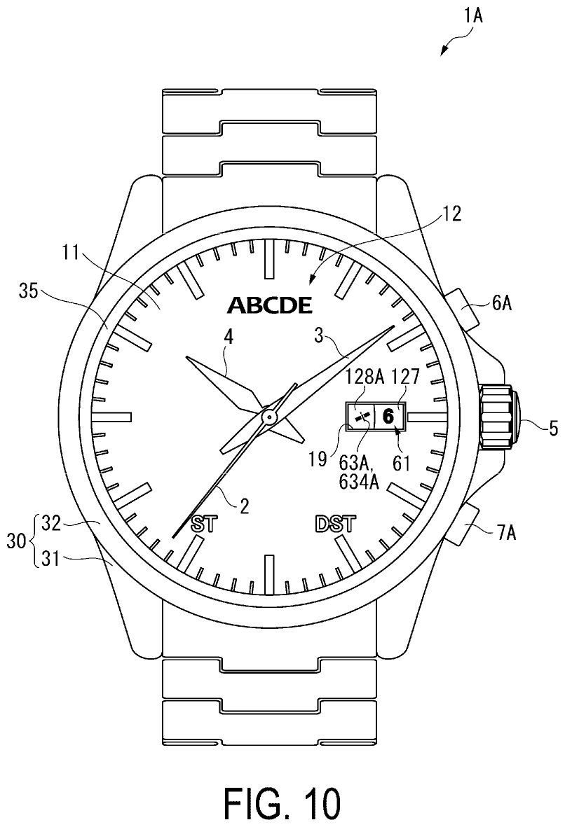

FIG. 10 is a front view schematically illustrating the electronic timepiece 1A of the second exemplary embodiment.

As illustrated in FIG. 10, the electronic timepiece 1A includes an A button 6A and a B button 7A.

Further, in this exemplary embodiment, the information indicator wheel 128A is marked with symbols 63A of a satellite icon 634A and the like, and the electronic timepiece 1A can display the satellite icon 634A and the like through the display window 19. Note that details of the symbols 63A marked on the information indicator wheel 128A will be described later.

Date Indicator and Information Indicator Wheel

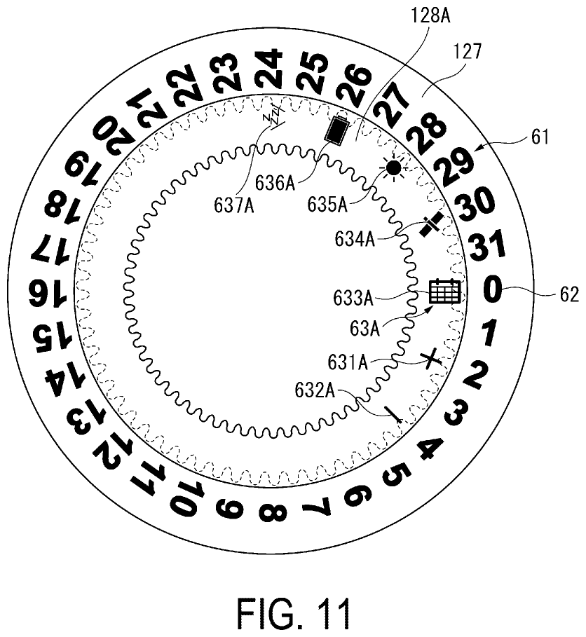

FIG. 11 is a drawing schematically illustrating the date indicator 127 and the information indicator wheel 128A.

As illustrated in FIG. 11, the information indicator wheel 128A has an annular shape and is disposed on the inner side of the date indicator 127. In this exemplary embodiment, the information indicator wheel 128A is marked with a plus sign 631A, a minus sign 632A, a calendar icon 633A, the satellite icon 634A, a sun icon 635A indicating an illumination level, a battery icon 636A indicating a battery level, and a power save icon 637A indicating power save mode as the symbols 63A indicating information.

Configuration of Electronic Timepiece

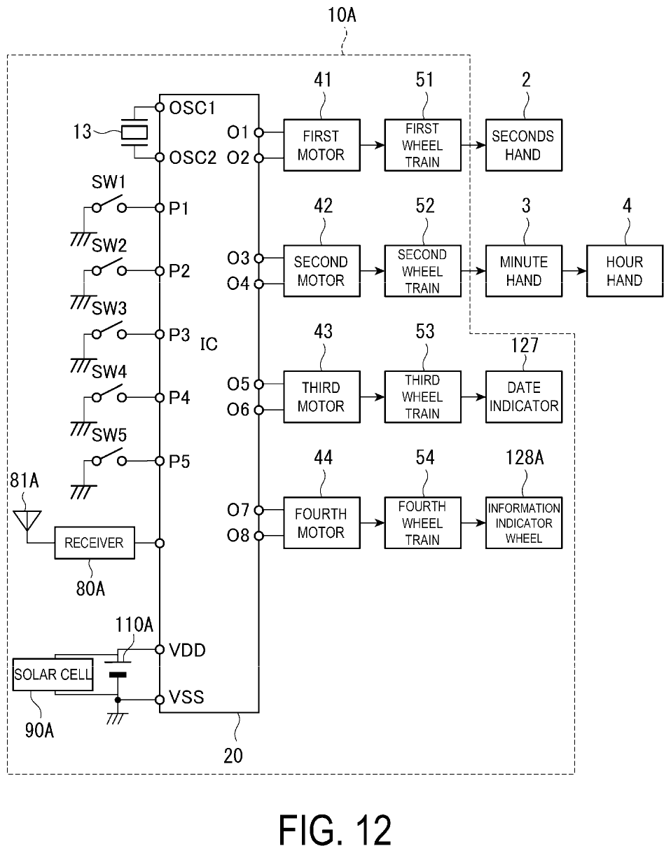

FIG. 12 is a drawing illustrating a circuit configuration of the electronic timepiece 1A.

As illustrated in FIG. 12, the electronic timepiece 1A includes a movement 10A. Then, the movement 10A of this exemplary embodiment includes a switch SW4 turned on and off in conjunction with operation of the A button 6A, a switch SW5 turned on and off in conjunction with operation of the B button 7A, a receiver 80A, an antenna 81A, a solar cell 90A, and a battery 110A.

The receiver 80A is configured to be capable of acquiring GPS time information and position information by receiving, via the antenna 81A, satellite signals transmitted from a plurality of satellites, such as a global position system (GPS) satellite and a quasi-zenith satellite, and processing the received satellite signals.

The receiver 80A, similar to a typical GPS device, includes a radio frequency (RF) unit configured to receive satellite signals and convert the signals into digital signals, a baseband unit (BB unit) configured to execute a correlation determination of the received signals to demodulate a navigation message, and an information acquisition unit configured to acquire and output GPS time information and position information from the navigation message demodulated by the BB unit.

The antenna 81A is provided to the indicator wheel holder 129 (refer to FIG. 2). That is, in this exemplary embodiment, the indicator wheel holder 129 is configured as a planar antenna that receives satellite signals transmitted from a GPS satellite or the like.

The battery 110A is configured as a secondary battery, such as a lithium ion battery, and is coupled to the solar cell 90A. Thus, the battery 110A is configured to be capable of recharging from the power generated by the solar cell 90A.

Here, in this exemplary embodiment, when the A button 6A is pressed for three seconds or longer, the control device 23 (refer to FIG. 6) is configured to initiate reception processing of the satellite signals by the receiver 80A. Then, when the reception processing is initiated, the control device 23 rotationally moves the date indicator 127 and the information indicator wheel 128A, and thus displays the number of satellites captured. That is, the control device 23 sets the display mode to number of captured satellites mode. For example, when the receiver 80A captures six satellites, the control device 23 rotationally moves the date indicator 127 and the information indicator wheel 128A, and thus displays, through the display window 19, the satellite icon 634A and “6” of the numerals 61, as illustrated in FIG. 10. Note that the display of the number of satellites obtained by combining the numerals 61 and the satellite icon 634A is an example of the function display of the present disclosure. During reception, by updating the number of satellites every second, for example, it is possible to continuously monitor the reception status.

Further, in the present exemplary embodiment, when the B button 7A is pressed, the control device 23 rotationally moves the date indicator 127 and the information indicator wheel 128A, and thus displays the level of the battery 110A. That is, the control device 23 sets the display mode to battery level mode. Specifically, the control device 23 rotationally moves the date indicator 127 and the information indicator wheel 128A, and thus displays, through the display window 19, the battery icon 636A and one of the numerals 61 from “0” to “10”. At this time, the control device 23 rotationally moves the date indicator 127 and displays “10” of the numerals 61 when the battery 110A is fully charged, and displays “0” of the numerals 61 when the level of the battery 110A is zero. That is, the electronic timepiece 1A is configured to display the level of the battery 110A in 11 stages from “0” to “10”.

Then, with the display mode is set to battery level mode, when the B button 7A is further pressed, the control device 23 rotationally moves the date indicator 127 and the information indicator wheel 128A, and thus displays the illumination level. That is, the display mode is set to illumination level mode. Specifically, the control device 23 rotationally moves the date indicator 127 and the information indicator wheel 128A, and thus displays, through the display window 19, the sun icon 635A and one of the numerals 61 from “0” to “10”. At this time, the control device 23 rotationally moves the date indicator 127 and thus displays “10” of the numerals 61 when the illumination level is highest, that is, when the power generation by the solar cell 90A is the greatest, and “0” of the numerals 61 when the illumination level is lowest, that is, when the solar cell 90A is not generating power. That is, the electronic timepiece 1A is configured to display the illumination level in 11 stages from “0” to “10”.

Furthermore, in this exemplary embodiment, when the level of the battery 110A falls below a predetermined threshold value, the electronic timepiece 1A is configured to set the display mode to power save mode. When power save mode is set, the control device 23 stops the movement of the seconds hand 2. Then, the control device 23 rotationally moves the information indicator wheel 128A, and thus displays the power save icon 637 through the display window 19. That is, the control device 23 sets the display mode to power save mode.

At this time, the control device 23 may be configured to set power save mode in stages. For example, in power save mode of a first stage, the movement of the seconds hand is stopped as described above and the information indicator wheel 128A is rotationally moved, displaying the power save icon 637A. Furthermore, the control device 23 rotationally moves the date indicator 127 and displays “1” of the numerals 61 to display that the mode is power save mode of the first stage. Then, in power save mode of the first stage, when the level of the battery 110A further decreases, the control device 23 sets power save mode of a second stage. In power save mode of the second stage, the control device 23 stops the movement of the minute hand 3 and the hour hand 4 in addition to the movement of the seconds hand 2. Then, the control device 23 rotationally moves the date indicator 127 and displays “2” of the numerals 61 to display that the mode is power save mode of the second stage.

Further, when an illumination level below the threshold value continues for a long time, the electronic timepiece 1A may be configured to set the display mode to power save mode.

Thus, in this exemplary embodiment, the electronic timepiece 1A is configured to switch the display mode to calendar mode, time difference information mode, number of captured satellites mode, battery level mode, illumination level mode, and power save mode. Note that the displays based on time difference information mode, number of captured satellites mode, battery level mode, illumination level mode, and power save mode are each an example of the function display of the present disclosure.

### Advantageous Effects of Second Exemplary Embodiment

According to such an exemplary embodiment, the following advantageous effects can be achieved.

In this exemplary embodiment, the electronic timepiece 1A, further includes the receiver 80A configured to capture at least one of a plurality of satellites to receive a satellite signal transmitted from the at least one of a plurality of satellites, and the numerals 61 and the symbols 63A are combined to display, as the function display, the number of the at least one of a plurality of satellites captured by the receiver 80A. Thus, the electronic timepiece 1A can display the number of captured satellites without separately providing a display mechanism for displaying the number of captured satellites. This makes it possible to improve user-friendliness and simplify the design of the dial ring 35 and the bezel 32.

In this exemplary embodiment, the electronic timepiece 1A can display the date, the time difference information, the number of captured satellites, the battery level, the illumination level, the power save mode, and the like by the numerals 61 marked on the date indicator 127 and the symbols 63A marked on the information indicator wheel 128A. This makes it possible to simplify the design of the dial ring 35 and the bezel 32 compared to when icons and the like related to this information are marked on the dial ring 35 and the bezel 32.

### Third Exemplary Embodiment

Next, an electronic timepiece 1B of a third exemplary embodiment of the present disclosure will be described with reference to the drawings.

The electronic timepiece 1B of the third exemplary embodiment differs from those of the first and second exemplary embodiments described above in that an information indicator wheel 128B is marked with a social networking service (SNS) icon 638B and the like. Note that components of the third exemplary embodiment that are identical or similar to the corresponding components of the first and second exemplary embodiments are denoted by identical reference signs and that descriptions of these components are omitted.

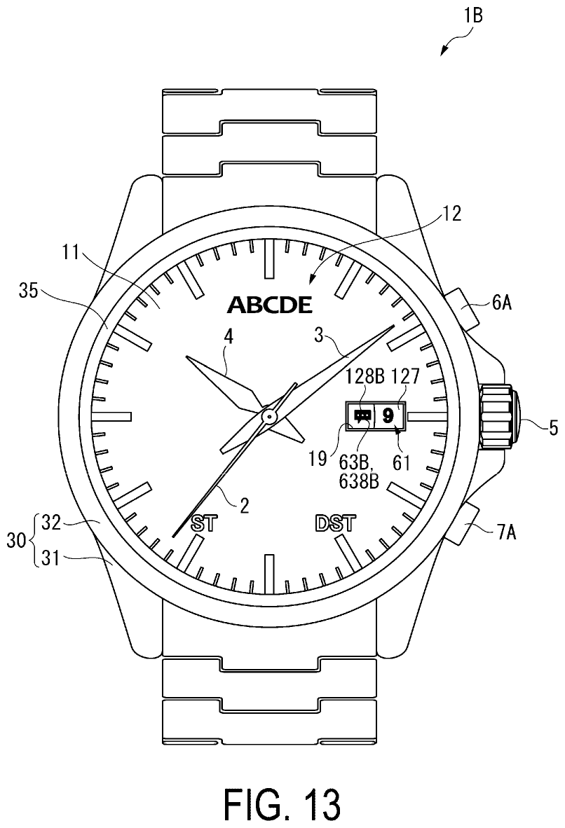

FIG. 13 is a front view schematically illustrating the electronic timepiece 1B of the third exemplary embodiment.

As illustrated in FIG. 13, in this exemplary embodiment, the information indicator wheel 128B is marked with symbols 63B such as the SNS icon 638B, and the electronic timepiece 1B can display the SNS icon 638B and the like through the display window 19. Note that details of the symbols 63B marked on the information indicator wheel 128B will be described later.

Date Indicator and Information Indicator Wheel

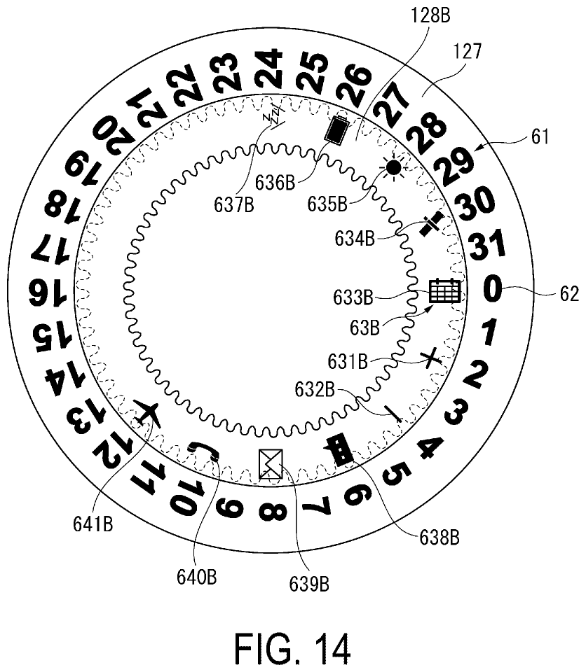

FIG. 14 is a drawing schematically illustrating the date indicator 127 and the information indicator wheel 128B.

As illustrated in FIG. 14, in this exemplary embodiment, the information indicator wheel 128B is marked with the SNS icon 638B, an email icon 639B, a call icon 640B, and an airplane icon 641B in addition to a plus sign 631B, a minus sign 632B, a calendar icon 633B, a satellite icon 634B, a sun icon 635B, a battery icon 636B, and a power save icon 637B, as the symbols 63B indicating information.

Configuration of Electronic Timepiece

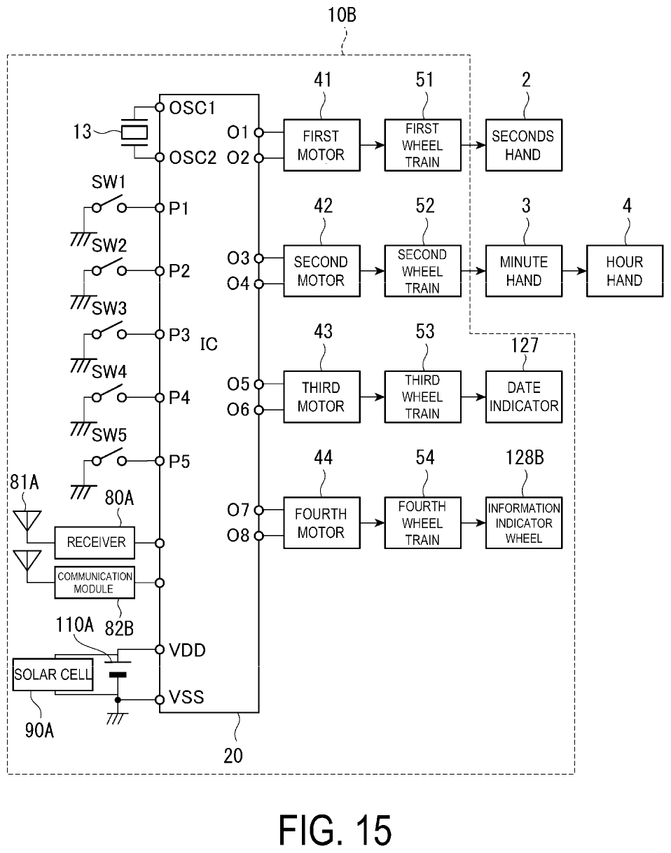

FIG. 15 is a drawing illustrating a circuit configuration of the electronic timepiece 1B.

As illustrated in FIG. 15, the electronic timepiece 1B includes a movement 10B. Then, the movement 10B of this exemplary embodiment includes a communication module 82B. In this exemplary embodiment, the communication module 82B is configured as a wireless communication module such as Bluetooth (trade name) or Wi-Fi (trade name), and is capable of communicating with a smart phone or the like.

Here, in this exemplary embodiment, when the smart phone communicating via the communication module 82B receives a new post of SNS, the number of new posts is transmitted from the smart phone to the electronic timepiece 1B. Then, the control device 23 rotationally moves the date indicator 127 and the information indicator wheel 128B, and thus displays the number of new posts of SNS. That is, the control device 23 sets the display mode to SNS mode. For example, when nine new posts of SNS are present, the control device 23 rotationally moves the date indicator 127 and the information indicator wheel 128B, and thus displays the SNS icon 638B and “9” of the numerals 61 through the display window 19, as illustrated in FIG. 13. Note that the display of the number of new posts of SNS is an example of the function display of the present disclosure.

Further, in this exemplary embodiment, when a smart phone communicating via the communication module 82B receives an email, the number of emails is communicated from the smart phone to the electronic timepiece 1B. Then, the control device 23 rotationally moves the date indicator 127 and the information indicator wheel 128B, and thus displays the number of received emails. That is, the control device 23 sets the display mode to email mode. Specifically, the control device 23 rotationally moves the date indicator 127 and the information indicator wheel 128B, and thus displays the email icon 639B and the numeral 61 corresponding to the number of received emails through the display window 19. Note that the display of the number of received emails is an example of the function display of the present disclosure.

Furthermore, in this exemplary embodiment, when a smart phone communicating via the communication module 82B receives a call, the number of calls is communicated from the smart phone to the electronic timepiece 1B. Then, the control device 23 rotationally moves the date indicator 127 and the information indicator wheel 128B, and thus displays the number of received calls. That is, the control device 23 sets the display mode to call mode. Specifically, the control device 23 rotationally moves the date indicator 127 and the information indicator wheel 128B, and thus displays the call icon 640B and the numeral 61 corresponding to the number of received calls through the display window 19. Note that the display of the number of received calls is an example of the function display of the present disclosure.

Further, in this exemplary embodiment, the electronic timepiece 1B is configured to set the display mode to flight mode. When flight mode is set, the control device 23 prohibits reception of satellite signals by the receiver 80A and wireless communication by the communication module 82B. Then, the control device 23 rotationally moves the information indicator wheel 128B, and thus displays the airplane icon 641B through the display window 19. That is, the control device 23 sets the display mode to flight mode.

Thus, in this exemplary embodiment, the electronic timepiece 1B is configured to switch the display mode to calendar mode, time difference information mode, number of captured satellites mode, battery level mode, illumination level mode, power save mode, SNS mode, email mode, call mode, and flight mode. Note that while a plurality of function displays are provided in this exemplary embodiment, a configuration may be one in which any one of the function displays is provided.

Further, in this exemplary embodiment, the electronic timepiece 1B may have an automatic dependent surveillance-broadcast (ADS-B) function. That is, the electronic timepiece 1B may be configured to be capable of receiving ADS-B signals transmitted from an airplane. In this case, the electronic timepiece 1B may be configured to be capable of displaying the number of ADS-B signals of the aircraft received during reception.

### Advantageous Effects of Third Exemplary Embodiment

According to such a third exemplary embodiment, the following advantageous effects can be achieved.

In this exemplary embodiment, the electronic timepiece 1B includes the communication module 82B configured to be capable of wireless communication with a smart phone or the like. Then, the electronic timepiece 1B is configured to be capable of displaying the number of new posts of SNS and the number of received emails as function displays. Therefore, even without checking a smart phone or the like, by checking the electronic timepiece 1B, the user can visually recognize the number of new posts of SNS, the number of received emails, the number of received calls, the setting of flight mode, and the like, making it possible to improve user-friendliness.

### Modification Examples

Note that the present disclosure is not limited to each of the exemplary embodiments described above, and variations, modifications, and the like within the scope in which the object of the present disclosure can be achieved are included in the present disclosure.

### First Modification Example

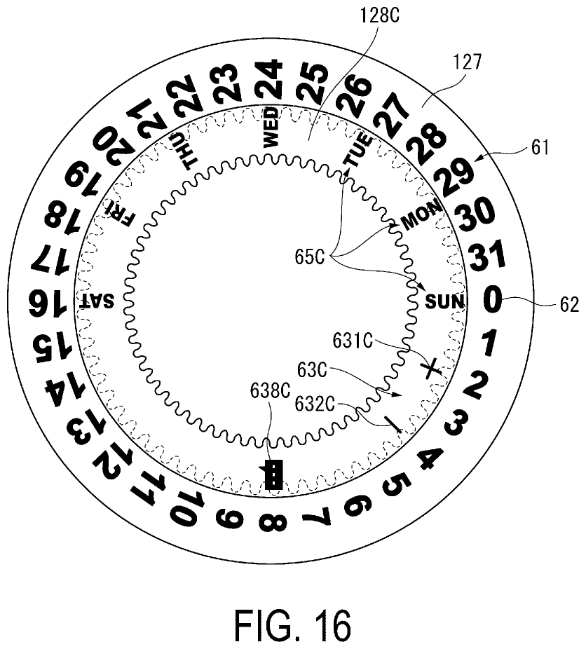

FIG. 16 is a drawing schematically illustrating the date indicator 127 and an information indicator wheel 128C of a first modification example.

As illustrated in FIG. 16, in addition to symbols 63C such as a plus sign 631C, a minus sign 632C, an SNS icon 638C, and the like, the information indicator wheel 128C is marked with characters indicating days of the week as day of the week information 65C. With this configuration, the date and the day of the week can be displayed simultaneously through the display window 19. That is, the day of the week can be displayed in the date display. Note that the display of the date and the day of the week is an example of the date display of the present disclosure. Further, the function display of the present disclosure does not include a day of the week display.

### Second Modification Example

While the electronic timepieces 1, 1A, 1B in the above-described exemplary embodiments include the information indicator wheels 128, 128A, 128B marked with the symbols 63, 63A, 63B, the present disclosure is not limited thereto.

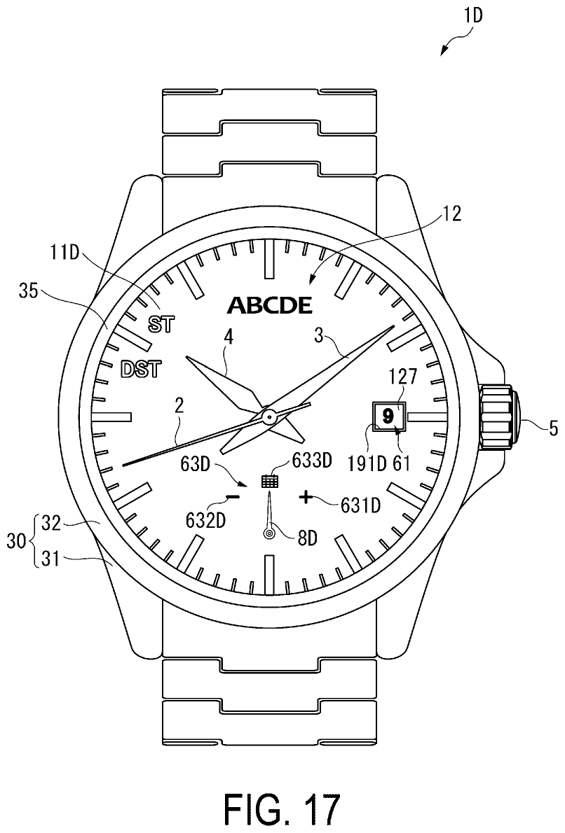

FIG. 17 is a front view schematically illustrating an electronic timepiece 1D of a second modification example.

As illustrated in FIG. 17, the electronic timepiece 1D may be marked, on a dial 11D, with symbols 63D such as a plus sign 631D, a minus sign 632D, a calendar icon 633D, and the like as information, and configured to point to the symbols 63D using an information indicating hand 8D. In this case, a date window 191D for enabling visual recognition of the numerals 61 may be provided to the dial 11D. Then, the electronic timepiece 1D may be configured to be capable of displaying a time difference information display, which is a function display, by combining the numerals 61 marked on the date indicator 127 and the symbols 63D pointed to by the information indicating hand 8D. That is, the electronic timepiece 1D may be configured to be switchable between the date display and the function display.

With this configuration, time difference information can be displayed without marking the dial ring 35, the bezel 32, and the like with characters and symbols. This makes it possible to display time difference information and the like and simplify the design of the dial ring 35 and the bezel 32.

### Third Modification Example

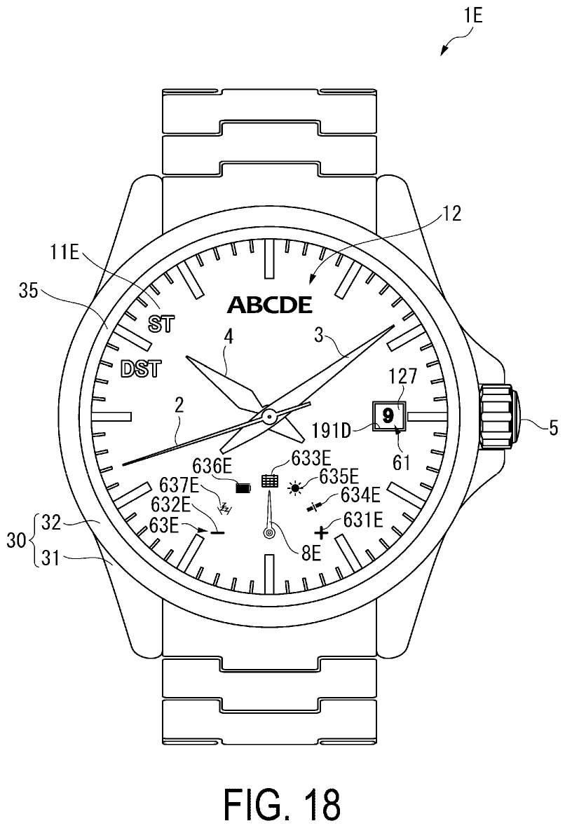

FIG. 18 is a front view schematically illustrating an electronic timepiece 1E of a third modification example.

As illustrated in FIG. 18, the electronic timepiece 1E may be marked, on a dial 11E, with symbols 63E such as a plus sign 631E, a minus sign 632E, a calendar icon 633E, a satellite icon 634E, a sun icon 635E, a battery icon 636E, a power save icon 637E and the like as information, and configured to point to the symbols 63E using an information indicating hand 8E. Then, the electronic timepiece 1E may be configured to be capable of displaying the number of captured satellites and the like by combining the numerals 61 marked on the date indicator 127 and the symbols 63E pointed to by the information indicating hand 8D.

### Fourth Modification Example

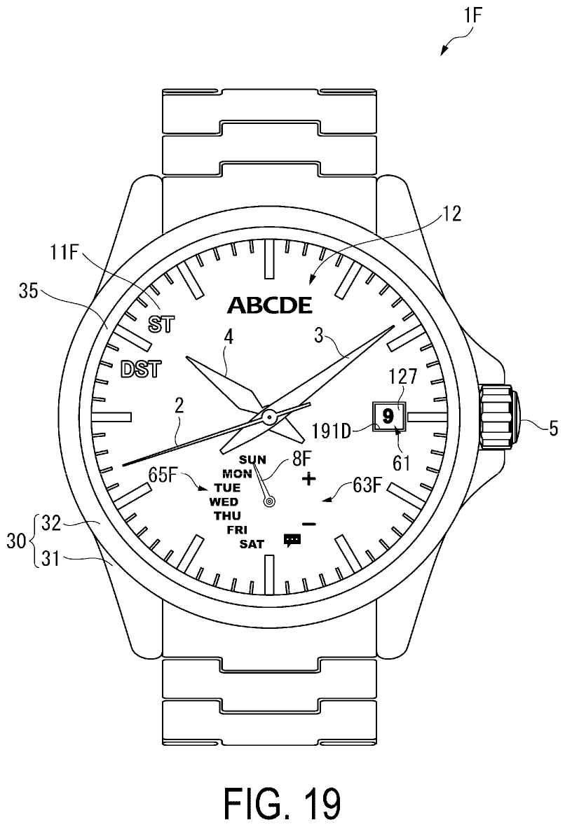

FIG. 19 is a front view schematically illustrating an electronic timepiece 1F of a fourth modification example.

As illustrated in FIG. 19, the electronic timepiece 1F may be marked, on a dial 11F, with characters indicating days of the week as day of the week information 63F in addition to symbols 63F. Then, the electronic timepiece 1F may be configured to be capable of simultaneously displaying the day of the week and the date by combining the day of the week information 65F pointed to by an information indicating hand 8F and the numerals 61 marked on the date indicator 127. That is, the information indicating hand 8F may be configured to point to the symbols 63F or to the day of the week information 65F.

### Fifth Modification Example

While the electronic timepieces 1, 1A, 1B in the above-described exemplary embodiments are configured to display the numerals 61 marked on the date indicator 127 and the symbols 63, 63A, 63B marked on the information indicator wheels 128, 128A, 128B through the display window 19, the present disclosure is not limited thereto.

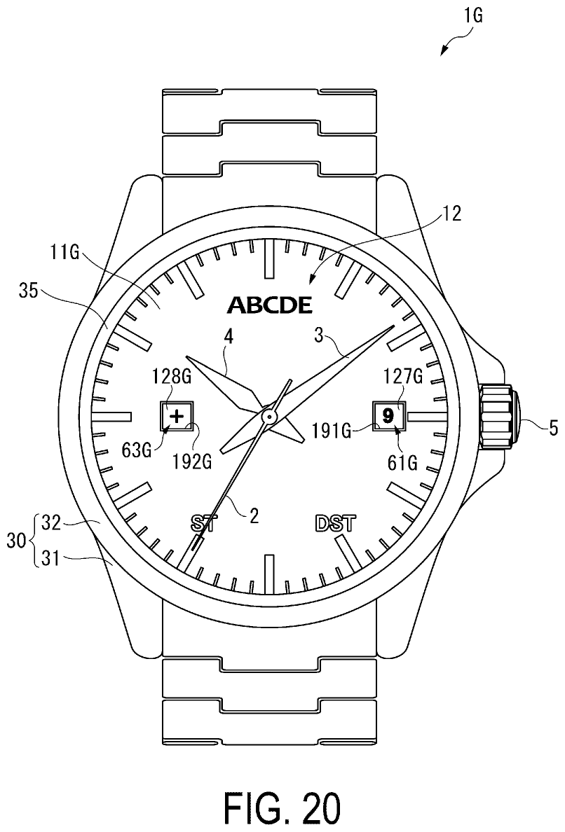

FIG. 20 is a front view schematically illustrating an electronic timepiece 1G of a fifth modification example.

As illustrated in FIG. 20, a dial 11G is separately provided with a date window 191G for enabling visual recognition of numerals 61G of a date indicator 127G, and an information window 192G for enabling visual recognition of symbols 63G of an information indicator wheel 128G.

### Sixth Modification Example

While the date indicator 172 in the above-described exemplary embodiments is marked with the numerals 61 and the character 62 of “0” or “UTC”, the present disclosure is not limited thereto. For example, in the second exemplary embodiment, the date indicator may be marked with the characters “H”, “M”, and “L” and the electronic timepiece may be configured to display the “H”, “M”, and “L”, thereby displaying the battery level, the illumination level, and the like. With this configuration, the displays of the battery level and the illumination level can be more easily understood.

Further, while the date indicator 127 is marked with the numerals 61 of “1” to “31” indicating dates in the above-described exemplary embodiments, the date indicator 127 may be marked with the characters of 32 and greater. For example, with the markings of 32 to 60 or 32 to 100, display variations of the function displays obtained by combining the information of the information indicator wheel and the numerals of the date indicator can be increased. For example, a time measurement display, a percent display, and the like become possible. Note that numerals of 32 and greater marked on the date indicator may be set as appropriate in consideration of visibility on the basis of a date indicator planar size, a display window size, and the like.

### Seventh Modification Example

While the above-described exemplary embodiments and the above-described first modification example illustrate, as examples, a plurality of pieces of information marked on the information indicator wheels 128, 128A, 128B, 128C, a plurality of city names having different time differences may be additionally marked. For example, a representative plurality of city names having different time differences across the globe can be marked along a circumference of the information indicator wheel, making it possible to simultaneously display the date and the city name through the display window 19. That is, the city name can be displayed in the date display. Note that the display of the date and the city name are an example of the date display of the present disclosure.

### Eighth Modification Example

While, in the above-described exemplary embodiments and the above-described modification examples, the electronic timepieces 1, 1A, 1B, 1D, 1E, 1F, 1G have a configuration in which the bezel 32 is fixed to the case body 31 and does not rotate, the present disclosure is not limited thereto. For example, the bezel may be a rotating type. With this configuration, the design variations can be increased. Further, the bezel may be integrally configured with the case. With this configuration, it is possible to reduce the size and reduce the cost of the electronic timepiece.

Further, in each of the above-described embodiments and the above-described modification examples, because the display function is performed by combining the numerals marked on the date indicator 127 and the information marked on the information indicator wheel 128, the electronic timepiece may be configured without the dial ring 35. With this configuration, it is possible to increase a parting diameter of the dial and improve time visibility. Further, it is possible to develop designs with and without dial rings, and increase the design variations.

### Ninth Modification Example

While, in the above-described exemplary embodiments, the information indicator wheels 128, 128A, 128B are disposed on the inner circumferential side of the date indicator 127, the present disclosure is not limited thereto. For example, the information indicator wheel may be disposed on an outer circumferential side of the date indicator. That is, the date indicator may be disposed on an inner circumferential side of the information indicator wheel. With this configuration, the area of the information indicator wheel that can be marked can be increased, making it possible to largely mark the information and thus make the information easy to view.

Further, while, in the above-described exemplary embodiments, the date indicator 127 and the information indicator wheels 128, 128A, 128B are disposed at substantially the same height position in the thickness direction of the electronic timepieces 1, 1A, 1B, the present disclosure is not limited thereto. For example, the date indicator and the information indicating wheel may have different height positions in the thickness direction of the electronic timepiece.

Furthermore, while, in the above-described exemplary embodiments, the date indicator and the information indicator wheels 128, 128A, 128B are formed into circular shapes, the present disclosure is not limited thereto. For example, at least one of the date indicator and the information indicator wheel may be formed into a plate shape, and the date indicator and the information indicator wheel may be disposed partially overlapping when viewed in plan view. Further, the date indicator and the information indicator wheel may have a configuration in which the respective positions of centers of rotation differ. For example, the axis of the center of rotation of the information indicator wheel may be disposed on the inner circumferential side of the date indicator formed into a circular shape, and the date indicator and the information indicator wheel may be disposed partially overlapping when viewed in plan view. Further, for example, the axis of the center of rotation of the information indicator wheel may be disposed on the outer circumferential side of the date indicator formed into a circular shape, and the date indicator and the information indicator wheel may be disposed partially overlapping when viewed in plan view. Further, the date indicator and the information indicator wheel may be disposed not overlapping when viewed in plan view. The configurations illustrated in these modification examples may be used alone or in combination, thereby making it possible to increase a degree of design freedom of the timepiece, increase the timepiece design variations, standardize the two indicator wheels, and the like.

Note that, in the present disclosure, the plan view is described as being a view from a direction orthogonal to the front surface of the date indicator and the information indicator wheel.

### Summary of Present Disclosure

An electronic timepiece of the present disclosure includes a first indicator wheel marked with numerals including dates, a second indicator wheel marked with a plurality of pieces of information, and a dial including a window configured to enable visual recognition of the numerals and the plurality of pieces of information. The electronic timepiece is configured to switch between a date display configured to use the numerals to display a date, and a function display obtained by combining the numerals and the plurality of pieces of information.

Thus, time difference information and the like can be displayed without marking the dial ring, the bezel, and the like with characters or symbols. This makes it possible to simplify the design of the dial ring and the bezel disposed on the outer edge of the dial visible surface.

In the electronic timepiece according to the present disclosure, one of the first indicator wheel and the second indicator wheel may be formed into an annular shape, and the other may be disposed in a space on an inner circumferential side of the annular shape.

Thus, one of the first indicator wheel and the second indicator wheel is provided in the space on the inner side of the other, making it possible to effectively utilize the space in the interior of the electronic timepiece. Therefore, the electronic timepiece can be miniaturized.

In the electronic timepiece according to the present disclosure, the second indicator wheel may be marked with, in addition to the plurality of pieces of information, day of the week information indicating a day of the week.

This makes it possible to simultaneously display the date and the day of the week in the date display.

The electronic timepiece according to the present disclosure may further include a first driving mechanism configured to drive the first indicator wheel, and a second driving mechanism configured to drive the second indicator wheel.

Thus, the first indicator wheel and the second indicator wheel are rotationally moved by different driving mechanisms, making it possible to rotationally move the first indicator wheel and the second indicator wheel to predetermined positions in a short time compared to when the first indicator wheel and the second indicator wheel are rotationally moved by the same driving mechanism.

An electronic timepiece of the present disclosure includes a first indicator wheel marked with numerals, including dates, a dial including a window configured to enable visual recognition of the numerals and marked with a plurality of pieces of information, and an information indicating hand configured to point to the plurality of pieces of information. The electronic timepiece is configured to switch between a date display configured to use the numerals to display a date, and a function display obtained by combining the numerals and the plurality of pieces of information.

Thus, time difference information and the like can be displayed without marking the dial ring, the bezel, and the like with characters or symbols. This makes it possible to simplify the design of the dial ring and the bezel disposed on the outer edge of the dial visible surface.

In the electronic timepiece according to the present disclosure, the dial may be marked with, in addition to the plurality of pieces of information, day of the week information indicating a day of the week, and the information indicating hand may be configured to point to the plurality of pieces of information or the day of the week information.

In the electronic timepiece according to the present disclosure, the first indicator wheel is marked with, in addition to the numerals, 0 or UTC, and the numerals, the plurality of pieces of information, and the 0 or the UTC may be combined to display, as the function display, time difference information.

This makes it possible to display time difference information for the time zone of “+0 hours”.

In the electronic timepiece according to the present disclosure, when the time difference information not including a decimal point is to be displayed, the numerals corresponding to the time difference information may be displayed through the window and, when the time difference information including a decimal point is to be displayed, a position between the numerals adjacent to each other may be displayed through the window in accordance with the time difference information. Thus, even with time difference information including a decimal point, the time difference information can be displayed by the numerals and the plurality of pieces of information.

The electronic timepiece according the present disclosure may further include a receiver configured to capture at least one of a plurality of satellites to receive a satellite signal transmitted from the at least one of a plurality of satellites, and the numerals and the plurality of pieces of information may be combined to display, as the function display, a number of the at least one of a plurality of satellites captured by the receiver.

This makes it possible to display, as the function display, the number of captured satellites without separately providing a dedicated display mechanism for displaying the number of captured satellites. Thus, user-friendliness can be improved and the design of the dial ring and the bezel can be simplified.

In the electronic timepiece according to the present disclosure, the numerals and the plurality of pieces of information may be combined to display, as the function display, at least one of a battery level, an illumination level, and a power save mode.

What is claimed is:

1. An electronic timepiece comprising:
a first indicator wheel marked with numerals, including a date;
a second indicator wheel marked with a plurality of pieces of information; and
a dial including a window configured to enable visual recognition of the numerals and the information, wherein
the electronic timepiece is configured to switch between a date display configured to use the numerals to display a date, and a function display obtained by combining the numerals and the information.

2. The electronic timepiece according to claim 1, wherein
one of the first indicator wheel and the second indicator wheel is formed into an annular shape, and the other is disposed in a space on an inner circumferential side of the annular shape.

3. The electronic timepiece according to claim 1, wherein
the second indicator wheel is marked with, in addition to the information, day of the week information indicating a day of the week.

4. The electronic timepiece according to claim 1, comprising:
a first driving mechanism configured to drive the first indicator wheel; and
a second driving mechanism configured to drive the second indicator wheel.

5. The electronic timepiece according to claim 1, wherein
the first indicator wheel is marked with, in addition to the numerals, 0 or UTC and
the numerals, the information, and the 0 or the UTC are combined to display, as the function display, time difference information.

6. The electronic timepiece according to claim 5, wherein
when the time difference information not including a decimal point is displayed, the numerals corresponding to the time difference information are displayed through the window and
when the time difference information including a decimal point is displayed, a position between the numerals adjacent to each other is displayed through the window in accordance with the time difference information.

7. The electronic timepiece according to claim 1, comprising:
a receiver configured to capture at least one of a plurality of satellites to receive a satellite signal transmitted from the at least one of a plurality of satellites, wherein
the numerals and the information are combined to display, as the function display, a number of the at least one of a plurality of satellites captured by the receiver.

8. The electronic timepiece according to claim 1, wherein
the numerals and the information are combined to display, as the function display, at least one of a battery level, an illumination level, and a power save mode.

9. An electronic timepiece comprising:
a first indicator wheel marked with numerals, including a date;
a dial including a window configured to enable visual recognition of the numerals, and marked with a plurality of pieces of information; and
an information indicating hand configured to point to the information, wherein
the electronic timepiece is configured to switch between a date display configured to use the numerals to display a date, and a function display obtained by combining the numerals and the information.

10. The electronic timepiece according to claim 9, wherein
the dial is marked with, in addition to the information, day of the week information indicating a day of the week and
the information indicating hand is configured to point to the information or the day of the week information.

11. The electronic timepiece according to claim 9, wherein
the first indicator wheel is marked with, in addition to the numerals, 0 or UTC and
the numerals, the information, and the 0 or the UTC are combined to display, as the function display, time difference information.

12. The electronic timepiece according to claim 11, wherein
when the time difference information not including a decimal point is displayed, the numerals corresponding to the time difference information are displayed through the window and
when the time difference information including a decimal point is displayed, a position between the numerals adjacent to each other is displayed through the window in accordance with the time difference information.

13. The electronic timepiece according to claim 9, comprising:
a receiver configured to capture at least one of a plurality of satellites to receive a satellite signal transmitted from the at least one of a plurality of satellites, wherein
the numerals and the information are combined to display, as the function display, a number of the at least one of a plurality of satellites captured by the receiver.

14. The electronic timepiece according to claim 9, wherein
the numerals and the information are combined to display, as the function display, at least one of a battery level, an illumination level, and a power save mode.
